(19) United States
(12) Patent Application Publication
(10) Pub. No.: US 2017/0039144 A1
(43) Pub. Date: Feb. 9, 2017

(54) LOADING DATA USING SUB-THREAD INFORMATION IN A PROCESSOR

(71) Applicant: Intel Corporation, Santa Clara, CA (US)

(72) Inventors: Ren Wang, Portland, OR (US); Kevin B. Theobald, Hillsboro, OR (US); Sameh Gobriel, Hillsboro, OR (US); Tsung-Yuan C. Tai, Portland, OR (US)

(21) Appl. No.: 14/820,802

(22) Filed: Aug. 7, 2015

(51) Int. Cl. G06F 12/12; G06F 12/08

(52) U.S. Cl. CPC G06F 12/123; G06F 12/0875; G06F 12/0862; G06F 12/0891; G06F 2212/1021; G06F 2212/30; G06F 2212/602; G06F 2212/69; G06F 2212/452

(57) ABSTRACT

In one embodiment, a processor includes a core to execute instructions, a cache memory coupled to the core, and a cache controller coupled to the cache memory. The cache controller, responsive to a first load request having a first priority level, is to insert data of the first load request into a first entry of the cache memory and set an age indicator of a metadata field of the first entry to a first age level, the first age level greater than a default age level of a cache insertion policy for load requests, and responsive to a second load request having a second priority level to insert data of the second load request into a second entry of the cache memory and to set an age indicator of a metadata field of the second entry to the default age level, the first and second load requests of a first thread. Other embodiments are described and claimed.

### BACKGROUND

In modern processors, many components including one or more cache memories can be integrated into a single integrated circuit along with one or more processing cores. While close location of data in such cache memories can improve locality and therefore performance, sometimes desired data is not maintained in a cache memory. Various techniques are used to determine what data to maintain in a cache memory and what data to evict. Such techniques can suffer from complexity and high overhead.

### BRIEF DESCRIPTION OF THE DRAWINGS

FIG. 1 is a simplified block diagram of at least one embodiment of a system for routing communications.

FIG. 2 is a simplified block diagram of at least one embodiment of a network device.

FIG. 3A is a block diagram of a cache memory in accordance with an embodiment of the present invention.

FIG. 3B is a block diagram of a cache memory in accordance with an embodiment of the present invention.

FIG. 4A is a block diagram of a cache memory in accordance with an embodiment of the present invention.

FIG. 4B is a block diagram of a cache memory in accordance with an embodiment of the present invention.

FIG. 5 is a flow diagram of an eviction/insertion method in accordance with an embodiment of the present invention.

FIG. 6 is a flow diagram of a method for handling a prefetch request miss in accordance with an embodiment.

FIG. 7 is a flow diagram of a method for handling incoming load requests in a memory controller in accordance with an embodiment.

FIG. 8 is a block diagram of a micro-architecture of a processor core in accordance with one embodiment of the present invention.

FIG. 9 is a block diagram of a micro-architecture of a processor core in accordance with a still further embodiment.

FIG. 10 is a block diagram of a processor in accordance with another embodiment of the present invention.

FIG. 11 is a block diagram of a representative SoC in accordance with an embodiment of the present invention.

FIG. 12 is a block diagram of a system in accordance with an embodiment of the present invention.

FIG. 13 is a block diagram illustrating an IP core development system that may be used to manufacture an integrated circuit to perform operations according to an embodiment.

### DETAILED DESCRIPTION

In some embodiments, user-level instructions of an instruction set architecture (ISA) may be provided, via a software/hardware co-optimization approach, to identify certain sub-application (and even sub-thread) priority interactions. In one embodiment, a user-level load with priority instruction and a user-level prefetch with priority instruction may be provided. In this way, embodiments may enable priority handling of particular data access requests to provide fine-grained, user-defined cache quality of service (QoS) for important data.

Although different instruction formats can be provided in different embodiments, in one particular use case, both load and prefetch instructions can be provided with a priority field to indicate priority of the data associated with the request. In one embodiment, a single bit indicator, such as a priority flag or other indicator, may be part of the instruction encoding, and set to indicate that the requested data is of high priority (in an implementation in which a single priority level is provided to indicate priority greater than normal or non-priority data). In other cases, the priority encoding portion of the instruction may be a priority field having multiple bits to indicate a relative priority of the data, where there may be multiple priority levels. For example, in an embodiment a two-bit priority field may provide for four levels of priority. In one example, a value of 00 may indicate normal or non-priority data and levels 01-11 may indicate three levels of priority greater than the non-priority data. In other cases, these four levels may include a low priority indicator to indicate a request for data that has a lower priority than this normal or non-priority level.

Referring now to Table 1, shown are example instruction encodings of user-level load and prefetch instructions, respectively. As seen, the general format of these instructions provides an encoding of the requested operation (which may be identified by an opcode), an address at which the requested data is located (which in an embodiment may be a virtual address), and a priority field to indicate a priority level, which as discussed above may be a single bit indicator or flag or a multi-bit priority level. Understand while shown with these example encodings, many variations and alternatives are possible.

TABLE 1

| | |
|---|---|
| LOAD | address X, priority A |
| PFLOAD | address Y, priority B |

In various embodiments, one or more cache memories of a processor may be controlled by a cache controller to operate according to a given replacement technique such as a least recently used (LRU) or pseudo-LRU policy to dynamically manage the age of cache lines and select an oldest line (in a LRU position) to evict when a new line is to be inserted into the cache (or portion of the cache), where no available line is present. A new line can be inserted into a most recently used (MRU) position, LRU position, or somewhere in between depending on the insertion policy and the property of the cache line. For example, in a multiple-age LRU scheme, an instruction load miss is inserted with a first age level corresponding to a newest age. In turn, a data load miss is inserted with a second age level, which is at least one age level lower than the first age level. The purpose of such replacement schemes is to maximize the overall performance by effectively utilizing a cache memory.

In various embodiments, high priority data (e.g., as indicated by software) for which low processing latency is desired and/or frequently accessed may be controlled to be maintained in a cache memory with a higher probability than other (e.g., normal) data. To achieve this effect, when data having a high priority is loaded, it is assigned with a newer age (e.g., the first age level as above) or closer to the MRU position, instead of a middle age level assigned to a non-priority data load. By associating higher priority data with a newer age level, there is a lower possibility for this high priority line to be evicted in the future, thus providing fine-grained cache QoS to achieve low latency. While the above example is described for demand loads, understand that the same principle applies equally to prefetch loads with priority.

Embodiments may further be applied to a memory controller (such as an integrated memory controller of a processor), which controls information communication with a memory coupled to the memory controller. For example assume an implementation in which a memory controller supports three classes of priority: high, medium, and low. In this implementation, a normal (demand) data read is tagged as medium priority and a prefetch is tagged as low priority. In this scheme a demand load with priority can be tagged as a high priority transaction to provide better latency response, while a prefetch request with priority can be tagged as a medium priority transaction.

Note that the fine-grained cache and memory access QoS for data may be applied to individual load requests within a thread. That is, in addition to associating a given thread with a particular priority, sub-thread priority changes or differences are possible, such that particular portions of threads (e.g., one or more particular networking flows) can be associated with a higher, and potentially different, priority than other portions of the thread. Embodiments may apply such techniques with very low overhead, as a given LRU insertion policy (and priority memory access mechanism) can be used and adapted as described herein.

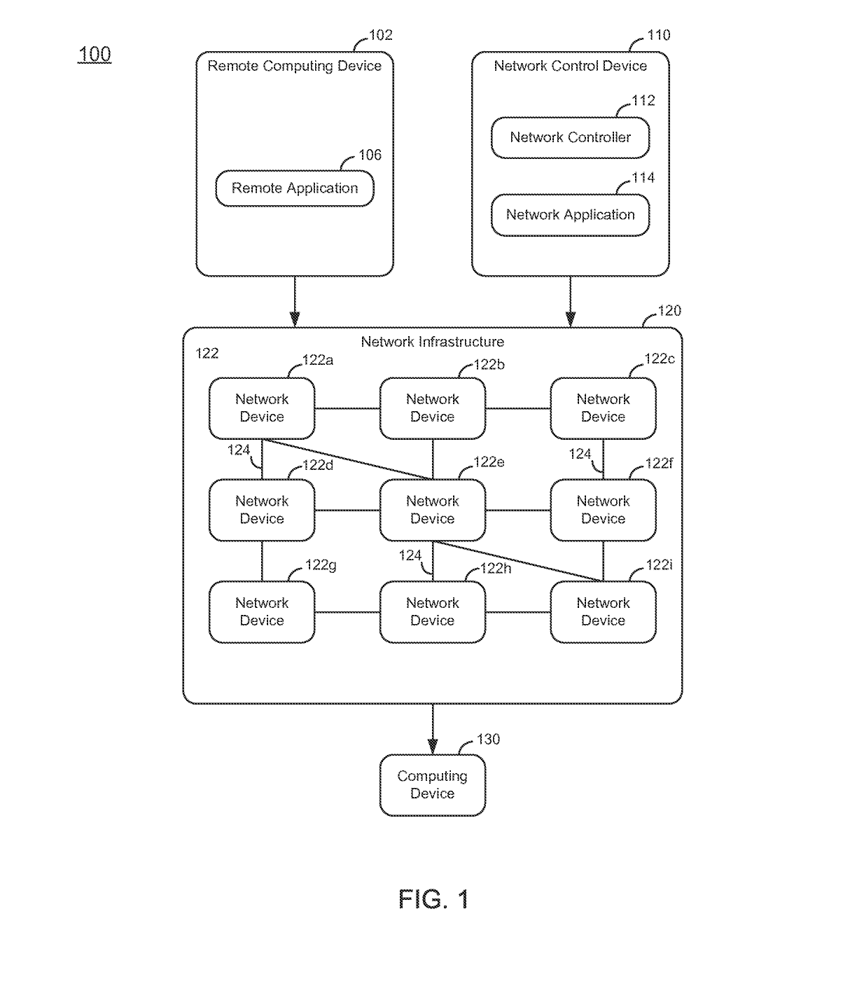

Referring now to FIG. 1, in an illustrative embodiment, a system or network 100 for network device flow lookup management includes a remote computing device 102 connected to a network control device 110 and a network infrastructure 120. Each of the network control device 110 and the network infrastructure 120 may be capable of operating in a software-defined networking (SDN) architecture and/or a network functions virtualization (NFV) architecture. The network infrastructure 120 includes at least one network device 122, illustratively represented as 122a-122h and collectively referred to herein as network devices 122, for facilitating the transmission of network packets between the remote computing device 102 and a computing device 130 via network communication paths 124.

In use, a network device 122 receives a network packet from the remote computing device 102, processes the network packet based on policies stored at the network device 122, and forwards the network packet to the next computing device (e.g., another network device 122, the computing device 130, the remote computing device 102, etc.) in the transmission path. To know which computing device is the next computing device in the transmission path, the network device 122 performs a lookup operation to determine a network flow. The lookup operation performs a hash on a portion of the network packet and uses the result to check against a flow lookup table (a hash table that maps to the network flow's next destination).

Typically, the flow lookup table is stored in an on-processor cache to reduce the latency of the lookup operation, while the network flows are stored in memory of the network device 122. However, flow lookup tables may become very large, outgrowing the space available in the on-processor cache. As such, portions of the flow lookup table (cache lines corresponding to network flow hash entries) are evicted to the memory of the network device 122, which introduces latency into the lookup operation. Additionally, which cache lines are evicted to memory is controlled by the network device based on whichever cache eviction algorithm is employed by the network device 122. However, in a multi-level flow hash table, certain levels of the multi-level flow hash table may be stored in the on-processor cache of the network device 122, while other levels of the multi-level flow hash table may be stored in the memory of the network device 122. For example, a multi-level flow hash table may include a first-level flow hash table to store higher priority level hashes stored in the on-processor cache, and a second-level flow hash table to store lower priority level hashes stored in the main memory. In such an embodiment, the overall latency attributable to the lookup operation may be reduced, in particular to those network flow hashes that have been identified to the network device 122 as having a high priority.

In use, the network packets are transmitted between the remote computing device 102 and the computing device 130 along the network communication paths 124 interconnecting the network devices 122 based on a network flow, or packet flow. The network flow describes a set, or sequence, of packets from a source to a destination. Generally, the set of packets share common attributes. The network flow is used by each network device 122 to indicate where to send received network packets after processing (i.e., along which network communication paths 124). For instance, the network flow may include information such as, for example, a flow identifier and a flow tuple (e.g., a source IP address, a source port number, a destination IP address, a destination port number, and a protocol) corresponding to a particular network flow. It should be appreciated that the network flow information may include any other type or combination of information corresponding to a particular network flow.

Note that the illustrative arrangement of the network communication paths 124 is intended to indicate there are multiple options (i.e., routes) for a network packet to travel within the network infrastructure 120, and should not be interpreted as a limitation of the illustrative network infrastructure 120. For example, a network packet travelling from the network device 122a to the network device 122e may be assigned a network flow directly from the network device 122a to the network device 122e. In another example, under certain conditions, such as a poor QoS over the network communication path 124 between the network device 122a and the network device 122e, that same network packet may be assigned a network flow instructing the network device 122a to transmit the network packet to the network device 122b, which in turn may be assigned a network flow instructing the network device 122b to further transmit the network packet to the network device 122e.

Network packet management information (e.g., the network flow, policies corresponding to network packet types, etc.) is managed by a network application 114 and provided to a network controller 112 running on the network control device 110. In order for the network application 114 to effectively manage the network packet management information, the network controller 112 provides an abstraction of the network infrastructure 120 to the network applications 114. In some embodiments, the network controller 112 may update the network packet management information based on a QoS corresponding to a number of available network flows or a policy associated to a particular workload type of the network packet. For example, the computing device 130 may send a request to the remote computing device 102 requesting that the remote computing device 102 provide a video stream for playback on the computing device 130. The remote computing device 102, after receiving the request, then processes the request and provides a network packet including data (i.e., payload data, overhead data, etc.) corresponding to content of the requested video stream to one of the network devices 122. At the receiving network device 122, the received network packet is processed before updating a header of the processed network packet with identification information of a target device for transmitting the processed network packet to. The receiving network device 122 then transmits the processed network packet to the target device according to the network flow provided by the network controller 112. The target device may be another network device 122 or the computing device 130 that initiated the request, depending where the receiving network device 122 resides in the network infrastructure 120.

The remote computing device 102 may be embodied as any type of storage device capable of storing content and communicating with the network control device 110 and the network infrastructure 120. In some embodiments, the remote computing device 102 may be embodied as any type of computation or computer device capable of performing the functions described herein, including, without limitation, a computer, a multiprocessor system, a server, a computing server (e.g., database server, application server, web server, etc.), a rack-mounted server, a blade server, a laptop computer, a notebook computer, a network appliance, a web appliance, a distributed computing system, a processor-based system, and/or a network-attached storage (NAS) device. The remote computing device 102 may include any type of components typically found in such devices such as processor(s), memory, I/O subsystems, communication circuits, and/or peripheral devices. While the system 100 is illustratively shown having one remote computing device 102, it should be appreciated that networks including more than one remote computing device 102 are contemplated herein. In some embodiments, the remote computing device 102 may additionally include one or more databases (not shown) capable of storing data retrievable by a remote application 106.

The illustrative remote computing device 102 includes the remote application 106. The remote application 106 may be embodied as any type of application capable of transmitting and receiving data to the computing device 130 via the network devices 122 of the network infrastructure 120. In some embodiments, the remote application 106 may be embodied as a web application (i.e., a thin client), a cloud-based application (i.e., a thin application) of a private, public, or hybrid cloud. Additionally, in some embodiments, the network flow priority provided by the network controller 112 may be based on information received by the network controller 112 from the remote application 106. In other words, the remote application 106 may provide information to the network controller 112 of the network flow priority to be assigned to certain network packet types from the remote application 106. For example, a streaming network flow, or real-time network flow, transmitted to the network device 122 by the remote application 106 may instruct the network controller 112 to indicate to the network device 122 that the flow priority of the streaming network flow is to be a high priority network flow, as compared to other network flows.

While the illustrative system 100 includes a single remote application 106, it should be appreciated that more than one remote application 106 may be running, or available, on the remote computing device 102. It should be further appreciated that, in certain embodiments, more than one remote computing device 102 may have more than one instance of the remote application 106 of the same type running across one or more of the remote computing devices 102, such as in a distributed computing environment.

The network control device 110 may be embodied as any type of computing device capable of executing the network controller 112, facilitating communications between the remote computing device 102 and the network infrastructure 120, and performing the functions described herein. For example, the network control device 110 may be embodied as, or otherwise include, a server computer, a desktop computer, a laptop computing device, a consumer electronic device, a mobile computing device, a mobile phone, a smart phone, a tablet computing device, a personal digital assistant, a wearable computing device, a smart television, a smart appliance, and/or other type of computing or networking device. As such, the network control device 110 may include devices and structures commonly found in a network control device or similar computing devices such as processors, memory devices, communication circuitry, and data storages, which are not shown in FIG. 1 for clarity of the description.

The network controller 112 may be embodied as, or otherwise include, any type of hardware, software, and/or firmware capable of controlling the network flow of the network infrastructure 120. For example, in the illustrative embodiment, the network controller 112 is capable of operating in a software-defined networking (SDN) environment (i.e., an SDN controller) and/or a network functions virtualization (NFV) environment (i.e., an NFV manager and network orchestrator (MANO)). As such, the network controller 112 may send (e.g., transmit, etc.) network flow information to the network devices 122 capable of operating in an SDN environment and/or a NFV environment. In an SDN architecture, an SDN network controller serves as a centralized network management application that provides an abstracted control plane for managing configurations of the network devices 122 from a remote location.

In use, the network controller 112 is configured to provide certain policy information, such as flow-based policies and cache management policies, to the network devices 122 as discussed in further detail below. The policy information may be based on the type of network packet, such as, a network packet with a streaming workload. For example, the policy information may include a priority corresponding to network flow types to each of the network devices 122. As noted previously, the priority of the network flow may be based on the type of network packet (e.g., workload type, payload type, network protocol, etc.). The network flow priority, received by each of the network devices 122 from the network controller 112, includes instructions for the network devices 122 to use when determining where to store the network flow information (i.e., in the memory 208 or in the cache 204).

The network application 114, commonly referred to in SDN networks as a business application, may be embodied as any type of network application capable of dynamically controlling the process and flow of network packets through the network infrastructure 120. For example, the network application 114 may be embodied as a network virtualization application, a firewall monitoring application, a user identity management application, an access policy control application, and/or a combination thereof. The network application 114 is configured to interface with the network controller 112, receive packets forwarded to the network controller 112, and manage the network flows provided to the network devices 122. In some embodiments, the network application 114 may be an SDN application or other compute software or platform capable of operating on an abstraction of the system 100 via an application programming interface (API). In some embodiments, such as where the network application 114 is an SDN application, the network application 114 may provide network virtualization services, such as virtual firewalls, virtual application delivery controllers, and virtual load balancers.

The computing device 130 is configured to transmit and/or receive network packets to/from the remote application 106 via the network devices 122. The computing device 130 may be embodied as, or otherwise include, any type of computing device capable of performing the functions described herein including, but not limited to a desktop computer, a laptop computing device, a server computer, a consumer electronic device, a mobile computing device, a mobile phone, a smart phone, a tablet computing device, a personal digital assistant, a wearable computing device, a smart television, a smart appliance, and/or other type of computing device. As such, the computing device 130 may include devices and structures commonly found in computing devices such as processors, memory devices, communication circuitry, and data storages, which are not shown in FIG. 1 for clarity of the description.

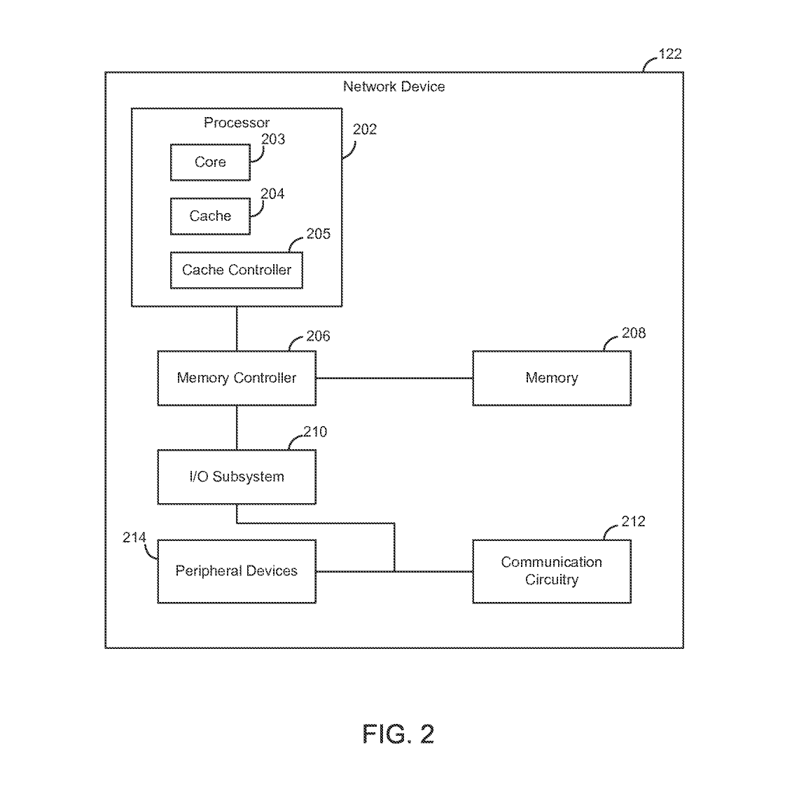

Referring now to FIG. 2, an illustrative network device 122 includes a processor 202 having a core 203 (which may be a representative one of multiple cores of a multicore processor) with an on-die cache memory 204, a cache controller 205, a memory controller 206 (which may be internal to processor 202 or a separate component, in different embodiments) to interface with a main memory 208. As seen, network device 122 further includes an input/output (I/O) subsystem 210, communication circuitry 212, and one or more peripheral devices 214. The network device 122 may be embodied as any type of computation or computer device capable of performing the functions described herein, including, without limitation, a general purpose computing device, a network appliance (e.g., physical or virtual), a web appliance, a router, a switch, a multiprocessor system, a server (e.g., stand-alone, rack-mounted, blade, etc.), a distributed computing system, a processor-based system, a desktop computer, a laptop computer, a notebook computer, a tablet computer, a smartphone, a mobile computing device, a wearable computing device, a consumer electronic device, or other computer device.

In use, as will be described in further detail below, when one of the network devices 122 receives the network flow information from the network controller 112, the network flow information is written to a network flow table, also commonly referred to as a routing table or a forwarding table. The network flow table is typically stored in the memory 208 (main memory) of the network device 122. Due to the latency associated with having to perform a lookup for the network flow information in the memory 208, the network flow information may be written to a hash table, or hash lookup table, typically stored in the cache 204 of the network device 122.

As will be described in further detail below, data may be stored in the on-die cache 204 or the memory 208. Data stored in the on-die cache 204 can be accessed at least an order of magnitude faster than data fetched from the memory 208. In other words, keeping certain data in the on-die cache 204 allows that data to be accessed faster than if that data resided in the memory 208. However, on-die cache 204 space is limited, so the network device 122 generally relies on a cache replacement algorithm, also commonly referred to as a replacement policy or cache algorithm, executed by cache controller 205 to determine which data to store in the on-die cache 204 and which data to evict to the memory 208. Each entry of the hash table is stored in a cache line of the on-die cache 204. Typically, cache replacement algorithms rely on hardware, e.g., of cache controller 205 to determine which cache lines to evict, as described further below. In some embodiments, the on-die cache 204 of the processor 202 may have a multilevel architecture. In such embodiments, data in the on-die cache 204 typically gets evicted from the lowest level of the on-die cache 204 to the highest level of the on-die cache 204, commonly referred to as last-level cache (LLC). When data is evicted from the highest level of the on-die cache 204 (the LLC), the data is generally written to the memory 208.

The processor 202 may be embodied as any type of processor capable of performing the functions described herein. For example, the processor 202 may be embodied as a single or multi-core processor(s), digital signal processor, microcontroller, or other processor or processing/controlling circuit. The memory 208 may be embodied as any type of volatile or non-volatile memory or data storage capable of performing the functions described herein. In operation, the memory 208 may store various data and software used during operation of the network device 122. The memory 208 is communicatively coupled to the processor 202 via the I/O subsystem 206, which may be embodied as circuitry and/or components to facilitate input/output operations with the processor 202, the memory 208, and other components of the network device 122. The I/O subsystem 206 is configured to facilitate the transfer of data to the on-die cache 204 and the memory 208. For example, the I/O subsystem 206 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 206 may form a portion of a system-on-a chip (SoC) and be incorporated, along with the processor 202, the memory 208, and other components of the network device 122, on a single integrated circuit chip.

The communication circuitry 212 may be embodied as any communication circuit, device, or collection thereof, capable of enabling communications between the remote computing device 102, the network control device 110 and other network devices 122 over a network. The communication circuitry 212 may be configured to use any one or more communication technologies (e.g., wireless or wired communications) and associated protocols (e.g., Ethernet, Bluetooth®, Wi-Fi®, WiMAX, etc.) to effectuate such communication. In some embodiments, the communication circuitry 212 includes cellular communication circuitry and/or other long-ranged wireless communication circuitry. The one or more peripheral devices 214 may include any type of peripheral device commonly found in a computing device, and particularly a network device, such as a hardware keyboard, input/output devices, peripheral communication devices, and/or the like, for example. It is contemplated herein that the peripheral devices 214 may additionally or alternatively include one or more ports for connecting external peripheral devices to the network device 122, such as USB, for example.

As mentioned above, cache memories can be configured with different policies, including eviction policies, insertion policies and so forth, where a given policy may be enforced by a cache controller. One eviction policy is a LRU policy, in which a least recently used cache line is evicted as a victim cache line when a new line is brought into the cache. Note that this policy may be applied to all lines of a cache, where each line is associated with a given recency of use (ranging from MRU to LRU), or can be applied on a sub-cache basis (e.g., on a set basis). And insertion may be performed according to a given insertion policy. In one embodiment, a default insertion policy is to insert cache lines for demand loads into a middle age position (e.g., approximately midway between MRU and LRU). The default insertion policy may further be configured to insert cache lines for prefetch loads to a lower age position (e.g., closer to the LRU position) than for demand loads.

In such a system, embodiments may configure the policies such that a cache line for a demand load request associated with higher priority data may be inserted into a position that is closer to the MRU position than for a demand load request for non-priority or normal data. As a result, the line with priority has a higher probability to stay in the cache memory longer. Embodiments may apply this priority tag with the request as it is passed to a memory controller, to cause the memory controller to assign a higher priority to this load request with priority, to further reduce latency associated with this request.

Note that a similar mechanism can be used for software prefetch operations to also provide fine-grained QoS, by prefetching data into a cache line having a position that is closer to the MRU position than a prefetch associated with non-priority data. Thus, while demand loads are primarily described herein, understand that embodiments may apply equally to prefetch activities.

As mentioned above, embodiments may be applied to perfect LRU and pseudo-LRU policies, as two exemplary implementations. In a perfect LRU system, an insertion for a new cache line is into the MRU position, with each of the other lines' ages via moving one step toward LRU position, and where the LRU position is selected for eviction. Note that other policies may insert a new line in different positions, based on their coarse grain thread behavior.

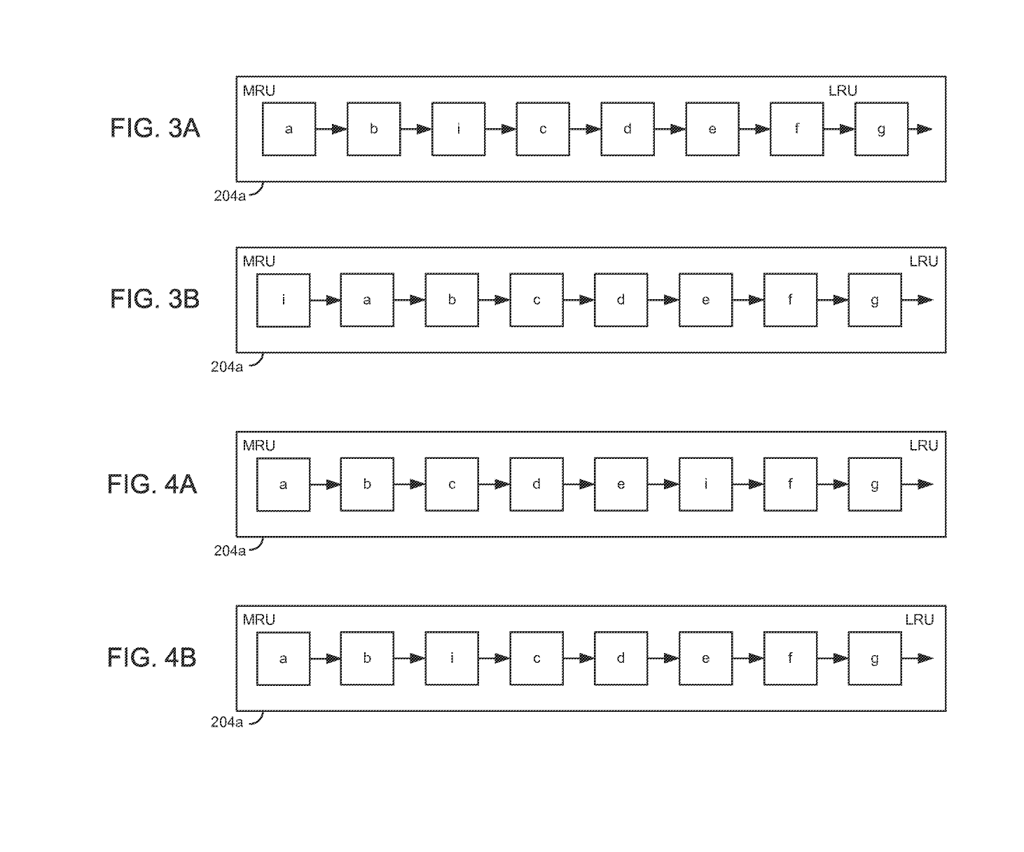

In an embodiment, in order to give certain special data higher cache priority than other normal data even within one thread, a high priority cache line is always inserted into a position closer to MRU position than a demand load without priority. An example of this is illustrated in FIGS. 3A and 3B, which show a block diagram of a cache memory 204a (which may be an entire cache memory or a set or other cache memory portion), in which a new line “I” without priority is inserted closer to the MRU position, in contrast to a typical true LRU policy, which would store this line in the MRU position. Exactly which positions to insert can vary and is implementation dependent. In this example assume now line “i” is for a load with priority on a cache miss, which is instead inserted into the MRU position as shown in FIG. 3B.

On a load hit, in a perfect LRU policy, a line is typically updated to the MRU position due to the higher locality. In an embodiment, a high priority line on a load hit may be updated to a position closer to the MRU position than a load hit with a normal cache line.

Prefetch operations may follow a similar policy; however the position of a new prefetched line typically is farther away from the MRU position than a demanded line (as shown in FIGS. 4B and 4B). As seen in FIG. 4A, for a non-priority prefetch, the line may be inserted more towards the LRU position. In contrast, as shown in FIG. 4B, a priority prefetch may be inserted more towards the MRU position.

In some cases, maintaining a perfect LRU policy may be computationally complex and have high overhead. Thus in some embodiments, a pseudo-LRU policy is used. One specific pseudo-LRU policy described herein is a quad-age LRU policy, in which cache lines can be associated with 1 of 4 ages (ranging from 0 to 3, with 3 being the newest age). The default insertion policy for such scheme may insert a new data line brought in on a demand load miss with age 2 (middle age), and adjust the line to age 3 on a load hit. In turn, a data line brought in responsive to a prefetch request may be inserted with age 1. Note that in some cases, an instruction demand can be inserted with age 3.

In this arrangement and assuming a single level of priority higher than a normal priority is provided, a new line brought into a cache memory responsive to a demand priority load request is inserted with age 3 (the newest age), and a new line brought into a cache memory responsive to a priority prefetch request is inserted with age 2 (newer than a normal priority prefetch).

While this priority policy is based on a quad-age LRU policy, understand that a given implementation can be different based on the specific pseudo-LRU policy. However the principle in various embodiments is to load/prefetch data having a higher priority to a newer age than a request for normal data. In addition, embodiments may adjust the priority line on a load hit to a newer age than a load hit on a normal line as well, based on implementation.

In certain modern memory controllers, incoming requests are tagged with one of multiple (e.g., 3) classes (e.g., high, medium, low). Normally, a data demand request received in a memory controller is tagged with a medium priority and a prefetch request received in the memory controller is tagged with a low priority. In an embodiment, in order to serve higher priority data requests as fast as possible, a load request for higher priority data may be tagged as a high priority request, while a prefetch request for higher priority data can be tagged as a medium priority request. Note that tagging given requests with higher priority may enable one or more arbitration circuits of the memory controller to prioritize such requests ahead of other requests, both on an outgoing path to a system memory and on an incoming path for return to a requester. In addition, in some embodiments the priority tagging may be included in memory requests to the system memory to additionally cause the memory to also prioritize such requests. Thus in various embodiments, a memory controller may be configured to serve, statistically, the data with priority with lower latency, and improve the overall QoS for important data.

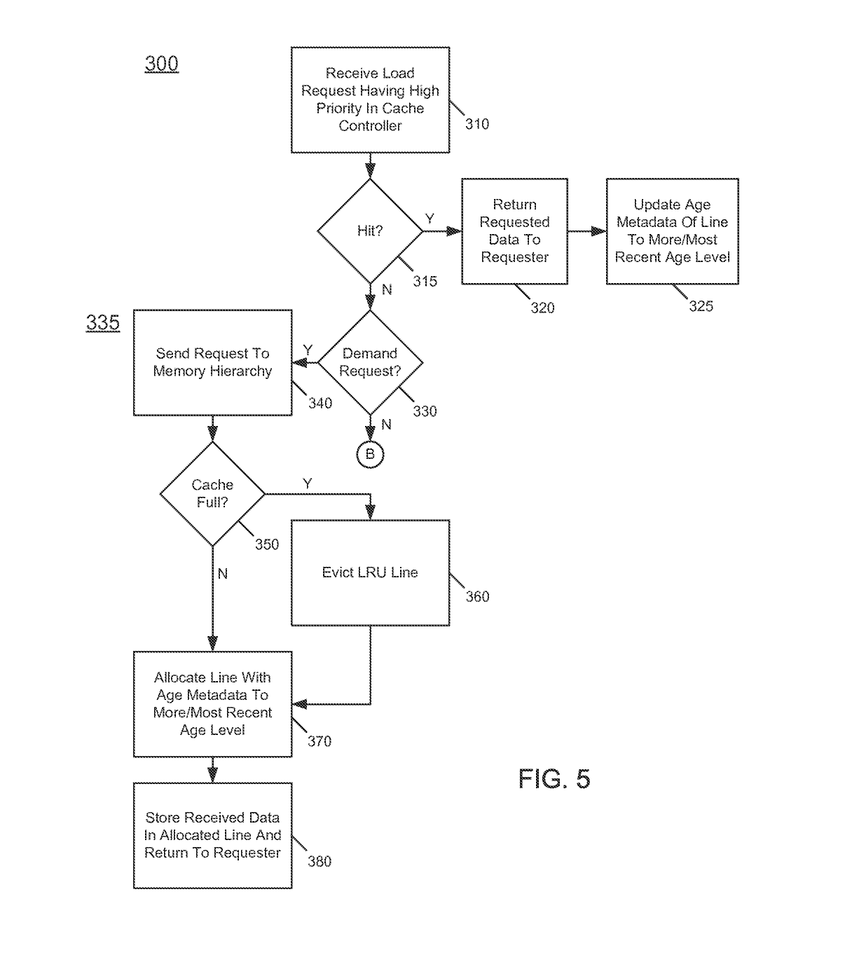

Referring now to FIG. 5, shown is a flow diagram of an eviction/insertion method in accordance with an embodiment of the present invention. As shown in FIG. 5, method 300 may be performed by various logic of a processor including, at least in part, insertion logic and eviction logic of a cache controller of the processor. As illustrated, method 300 begins by receiving a load request that has a high priority (block 310). In an embodiment, this load request may be received from a core or other IP logic of the processor or from another location. For purposes of discussion, assume a single level priority scheme in which a priority indicator is provided with a given request to indicate that the request has higher priority than a default or non-priority request.

At diamond 315 it is determined whether a hit occurs within the cache memory. If so, the requested data is returned to the requester (block 320). Still further, at block 325 age metadata associated with the hit cache line can be updated. More specifically in one embodiment, e.g., according to a LRU or pseudo-LRU scheme, this age metadata can be updated to indicate that the hit line is the most recently used line. Understand that in other embodiments, instead of associating the hit line with most recent status, the line instead may be associated closer, but not all the way, to the most recently used position. In some embodiments, this may entail moving the data of the line to a MRU position. In other embodiments, an age field of the cache line can simply be updated to indicate that it is the most recently used line.

If instead a requested line is not present in the cache, control passes to diamond 330 to determine whether the load request is a demand request. If a demand request, control passes to a miss flow 335 for handling a demand request miss. At block 340, the request is sent to a memory hierarchy. Next, at diamond 350 it is determined whether the cache is full. In different embodiments, this determination may be made on an entire cache basis, or in other cases, a cache can be partitioned, e.g., into different sets such that the determination of fullness can be with regard to a particular set. If the cache is full, control passes to block 360 where the LRU line may be evicted. Such eviction may cause modified data, if present in the line, to be written to further levels of a memory hierarchy, e.g., to another or different cache level within the processor or to system memory.

In any case, control passes next to block 370 where a line may be allocated for the miss data. More specifically, this line may be allocated with age metadata set to a more recent or most recently used level. As described above, in different implementations, responsive to a high priority demand request a line can be allocated to the MRU position, while in other cases the line can be allocated to a position closer, but not all the way, to the MRU position. Thereafter at block 380 the data is received from the memory hierarchy and is returned to the requester, as well as stored in the allocated cache line. Understand while shown with this particular implementation in FIG. 5, many variations and alternatives are possible.

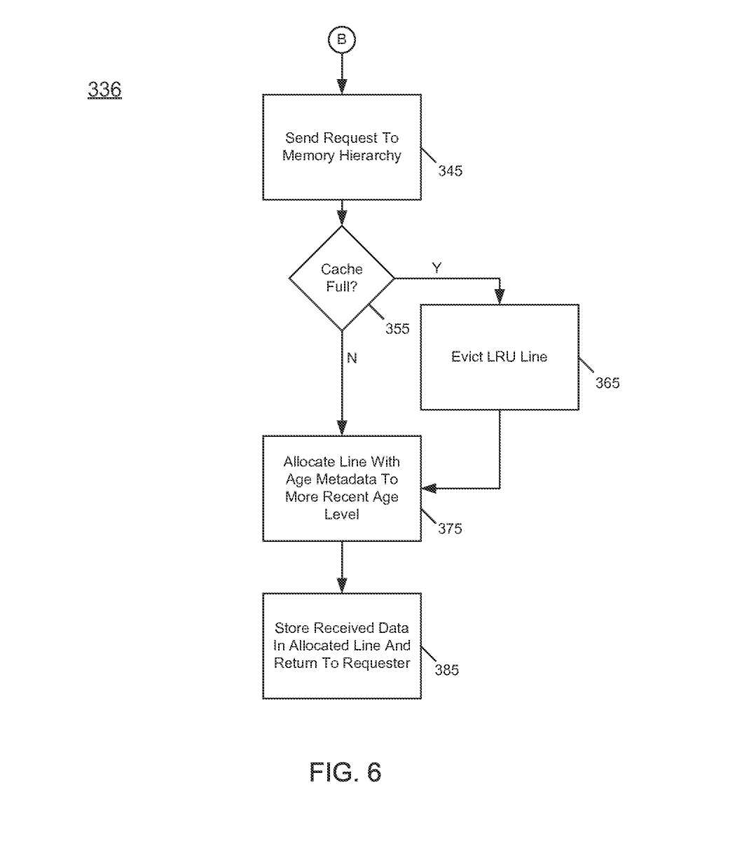

Referring now to FIG. 6, shown is a flow diagram of a method for handling a prefetch request miss in accordance with an embodiment. More specifically, FIG. 6 shows a flow 336 which may proceed when it is determined at diamond 330 (of FIG. 5) that an incoming load request is not a demand request, but instead is a prefetch request. Generally, flow 336 proceeds similarly as flow 335, with the request being provided to the memory hierarchy (block 345), determining whether the cache is full (diamond 355), and LRU eviction, if needed (block 365). However, note that in this embodiment, at block 375, the line to be allocated to the missed data is provided with age metadata set to a more recent level. That is, given that the request is a prefetch request, even though it is for high priority data, the request is not allocated to a cache line with as high a priority as a demand miss. In other respects, flow 336 proceeds the same as discussed above for flow 335, such that the returned data is stored in the allocated line and returned to the requester (block 385).

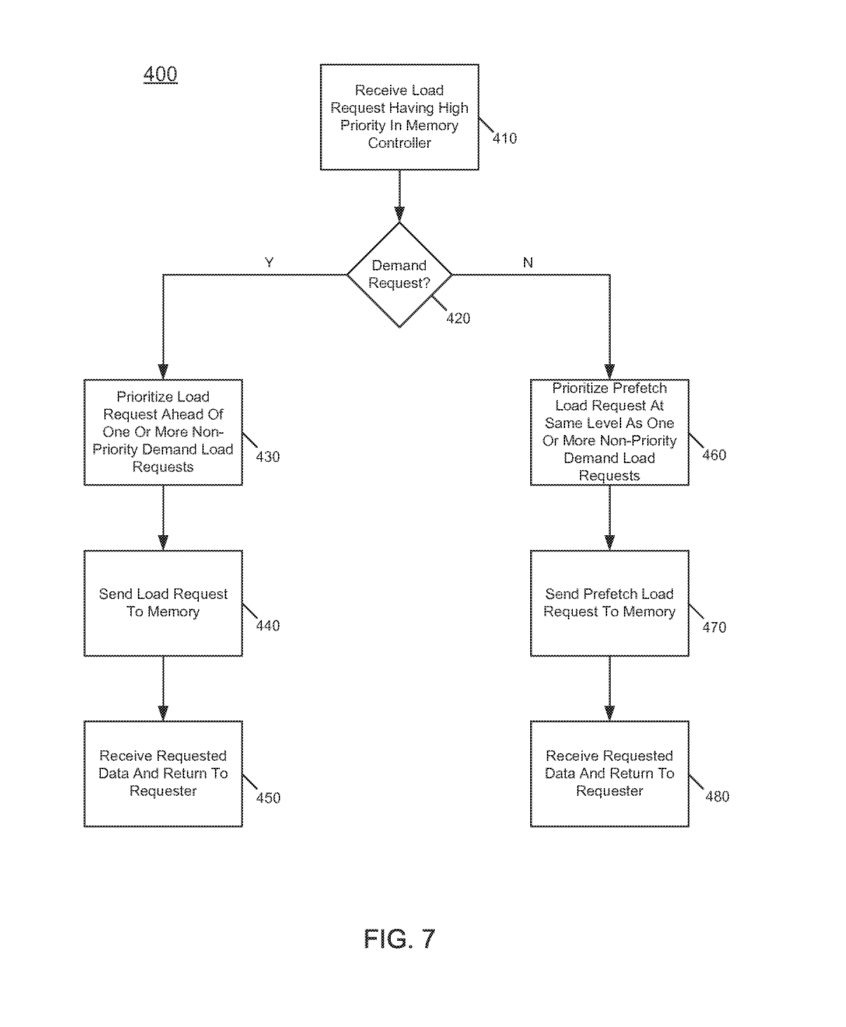

Referring now to FIG. 7, shown is a flow diagram of a method for handling incoming load requests in a memory controller in accordance with an embodiment. As shown in FIG. 7, method 400 may be implemented at least in part using arbitration logic of a memory controller, which may be configured to allocate a selected one of multiple incoming requests to be provided to a memory. More specifically, the memory controller may include one or more arbitration circuits to select, according to a given arbitration scheme, one of multiple incoming requests to be handled in a particular arbitration round.

As illustrated, method 400 begins by receiving a load request having high priority in the memory controller (block 410). Next it is determined at diamond 420 if the request is a demand request. This determination may be based, in an embodiment, on a priority indicator associated with the load request.

If the request is determined to be a demand request, control passes to block 430 where this load request may be prioritized ahead of one or more non-priority load requests. Note also that at block 430 the load request may also be prioritized ahead of one or more priority and/or non-priority prefetch requests. As such, at block 440 this prioritized load request is sent to the memory to be fulfilled. Then at block 450 the requested data is received and returned to the requester.

Instead when the request is determined to be a prefetch request, control passes to block 460 where this prefetch request may be prioritized at the same level as one or more non-priority demand load requests (and of course, ahead of one or more non-priority prefetch requests). When selected as an arbitration round winner, at block 470 this prioritized prefetch request is sent to the memory to be fulfilled. Then at block 480 the requested data is received and returned to the requester. Understand while shown at this high level in the embodiment of FIG. 7, many variations and alternatives are possible.

In one example use case, a flow classification workload may be executed on a processor (e.g., a general-purpose or special-purpose processor). This workload may have a large number of network flows, with at least some of them having higher QoS requirements. Yet other flows (usually not the high priority flows) may be accessed more frequently than others. In such cases, individual packet serving latency for those high priority flows may be higher than the latency of non-priority flows. Using an embodiment, many applications that require fine-grained data level QoS (within one thread) can benefit from reduced latencies. Although the scope of the present invention is not limited in this regard, high performance computing (HPC) workloads, high frequency trading (HFT) workloads such as for financial trading transactions, and real-time workloads such as voice traffic, among others, may use embodiments as described herein. Thus using embodiments, high priority flows when loaded into a cache memory are loaded with higher priority age metadata, and lower priority flows can be loaded with lower priority age metadata, so the data of the high priority flows remain resident, that is, stay longer in the cache memory.

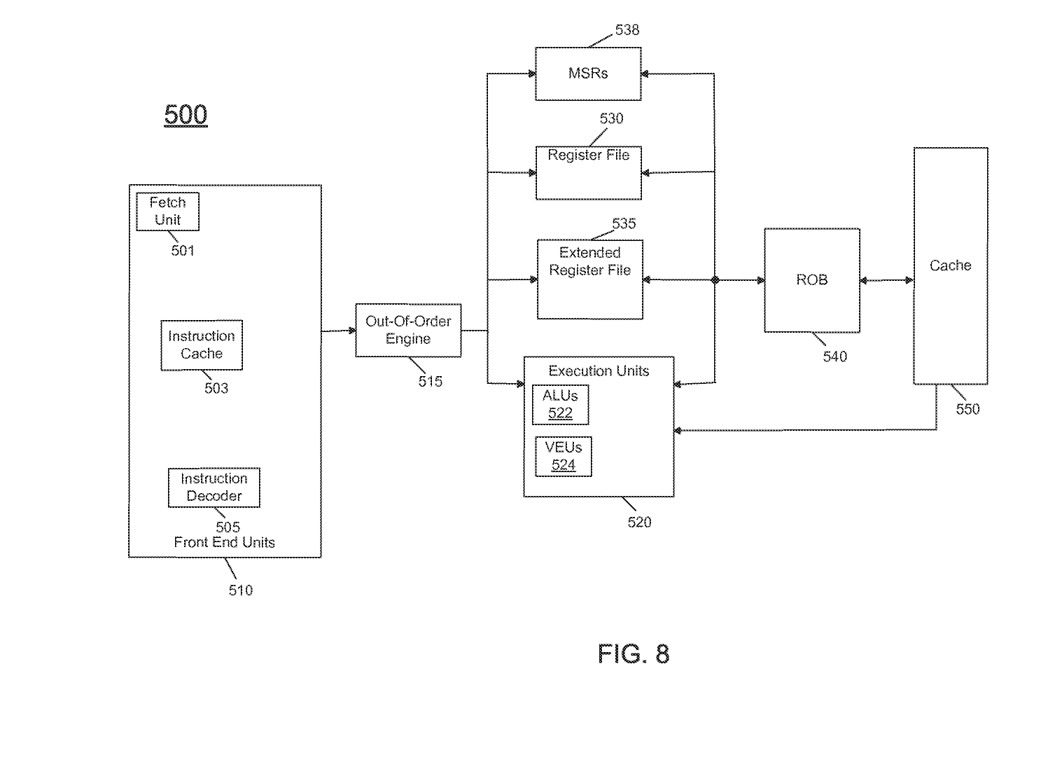

Referring now to FIG. 8, shown is a block diagram of a micro-architecture of a processor core in accordance with one embodiment of the present invention. As shown in FIG. 8, processor core 500 may be a multi-stage pipelined out-of-order processor. Core 500 may operate at various voltages based on a received operating voltage, which may be received from an integrated voltage regulator or external voltage regulator.

As seen in FIG. 8, core 500 includes front end units 510, which may be used to fetch instructions to be executed and prepare them for use later in the processor pipeline. For example, front end units 510 may include a fetch unit 501, an instruction cache 503, and an instruction decoder 505. In some implementations, front end units 510 may further include a trace cache, along with microcode storage as well as a micro-operation storage. Fetch unit 501 may fetch macro-instructions, e.g., from memory or instruction cache 503, and feed them to instruction decoder 505 to decode them into primitives, i.e., micro-operations for execution by the processor.

Coupled between front end units 510 and execution units 520 is an out-of-order (OOO) engine 515 that may be used to receive the micro-instructions and prepare them for execution. More specifically OOO engine 515 may include various buffers to re-order micro-instruction flow and allocate various resources needed for execution, as well as to provide renaming of logical registers onto storage locations within various register files such as register file 530 and extended register file 535. Register file 530 may include separate register files for integer and floating point operations. For purposes of configuration, control, and additional operations, a set of machine specific registers (MSRs) 538 may also be present and accessible to various logic within core 500 (and external to the core).

Various resources may be present in execution units 520, including, for example, various integer, floating point, and single instruction multiple data (SIMD) logic units, among other specialized hardware. For example, such execution units may include one or more arithmetic logic units (ALUs) 522 and one or more vector execution units 524, among other such execution units.

Results from the execution units may be provided to retirement logic, namely a reorder buffer (ROB) 540. More specifically, ROB 540 may include various arrays and logic to receive information associated with instructions that are executed. This information is then examined by ROB 540 to determine whether the instructions can be validly retired and result data committed to the architectural state of the processor, or whether one or more exceptions occurred that prevent a proper retirement of the instructions. Of course, ROB 540 may handle other operations associated with retirement.

As shown in FIG. 8, ROB 540 is coupled to a cache 550 which, in one embodiment may be a low level cache (e.g., an L1 cache) although the scope of the present invention is not limited in this regard. Cache memory 550 may include a cache controller to perform fine-grained cache accesses based on QoS information, such that higher priority requests can be handled with priority and remain resident in the cache longer. Also, execution units 520 can be directly coupled to cache 550. From cache 550, data communication may occur with higher level caches, system memory and so forth. While shown with this high level in the embodiment of FIG. 8, understand the scope of the present invention is not limited in this regard. For example, while the implementation of FIG. 8 is with regard to an out-of-order machine such as of an Intel® x86 instruction set architecture (ISA), the scope of the present invention is not limited in this regard. That is, other embodiments may be implemented in an in-order processor, a reduced instruction set computing (RISC) processor such as an ARM-based processor, or a processor of another type of ISA that can emulate instructions and operations of a different ISA via an emulation engine and associated logic circuitry.

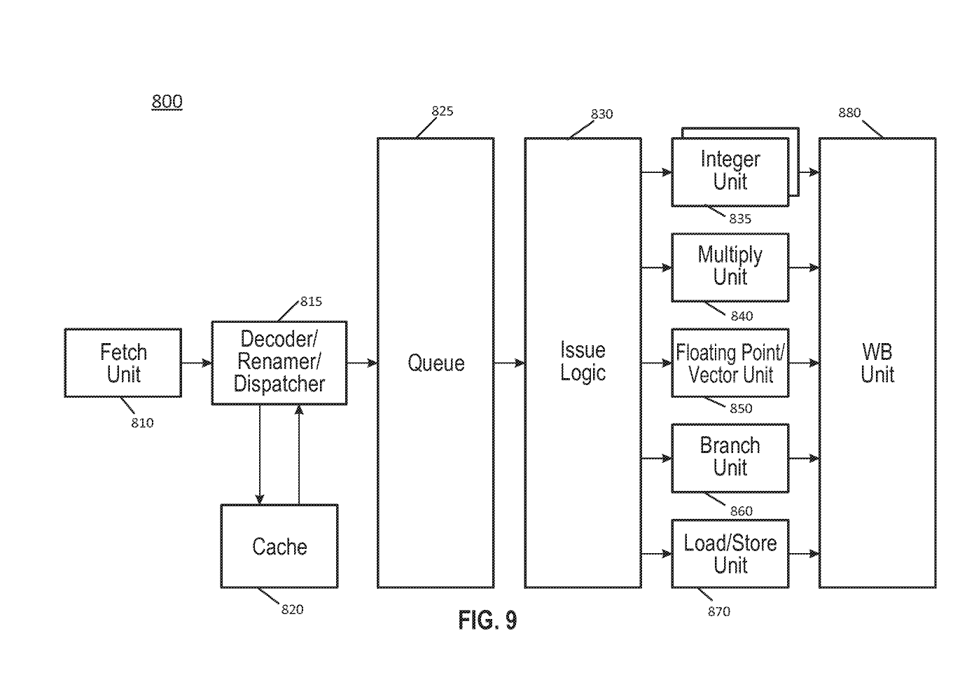

Referring to FIG. 9, shown is a block diagram of a micro-architecture of a processor core in accordance with a still further embodiment. As illustrated in FIG. 9, a core 800 may include a multi-stage multi-issue out-of-order pipeline to execute at very high performance levels. As one such example, processor 800 may have a microarchitecture in accordance with an ARM Cortex A57 design. In an implementation, a 15 (or greater)-stage pipeline may be provided that is configured to execute both 32-bit and 64-bit code. In addition, the pipeline may provide for 3 (or greater)-wide and 3 (or greater)-issue operation. Core 800 includes a fetch unit 810 that is configured to fetch instructions and provide them to a decoder/renamer/dispatcher unit 815 coupled to a cache 820 which may include a cache controller to perform fine-grained accesses associated with priority network flows as described herein. Unit 815 may decode the instructions, e.g., macro-instructions of an ARMv8 instruction set architecture, rename register references within the instructions, and dispatch the instructions (eventually) to a selected execution unit. Decoded instructions may be stored in a queue 825. Note that while a single queue structure is shown for ease of illustration in FIG. 9, understand that separate queues may be provided for each of the multiple different types of execution units.

Also shown in FIG. 9 is an issue logic 830 from which decoded instructions stored in queue 825 may be issued to a selected execution unit. Issue logic 830 also may be implemented in a particular embodiment with a separate issue logic for each of the multiple different types of execution units to which issue logic 830 couples.

Decoded instructions may be issued to a given one of multiple execution units. In the embodiment shown, these execution units include one or more integer units 835, a multiply unit 840, a floating point/vector unit 850, a branch unit 860, and a load/store unit 870. In an embodiment, floating point/vector unit 850 may be configured to handle SIMD or vector data of 128 or 256 bits. Still further, floating point/vector execution unit 850 may perform IEEE-754 double precision floating-point operations. The results of these different execution units may be provided to a writeback unit 880. Note that in some implementations separate writeback units may be associated with each of the execution units. Furthermore, understand that while each of the units and logic shown in FIG. 9 is represented at a high level, a particular implementation may include more or different structures.

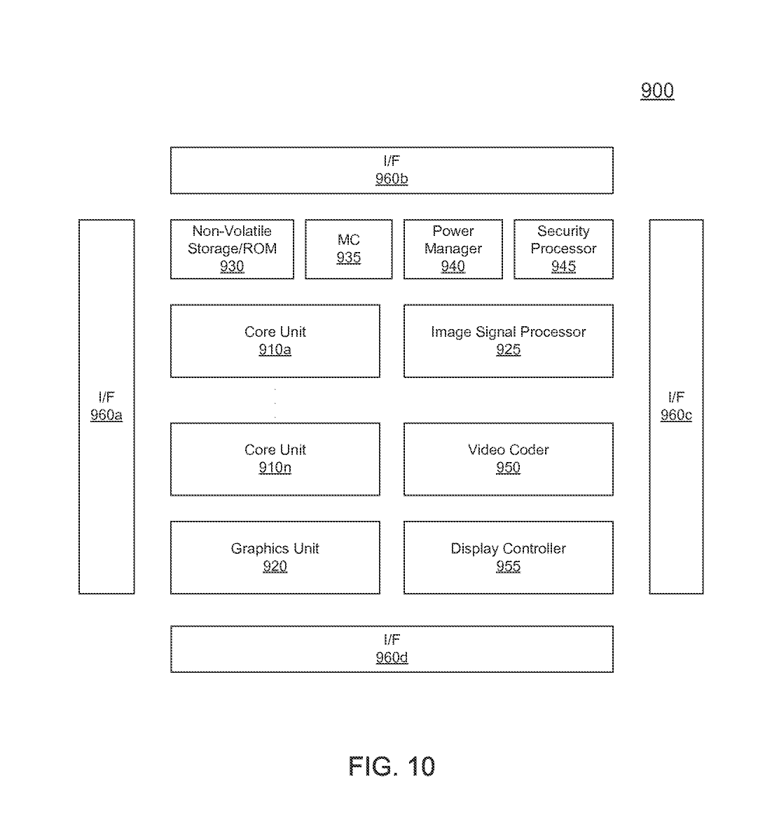

A processor designed using one or more cores having pipelines as in any one or more of FIGS. 8-9 may be implemented in many different end products, extending from mobile devices to server systems. Referring now to FIG. 10, shown is a block diagram of a processor in accordance with another embodiment of the present invention. In the embodiment of FIG. 10, processor 900 may be a SoC including multiple domains, each of which may be controlled to operate at an independent operating voltage and operating frequency. As a specific illustrative example, processor 900 may be an Intel® Architecture Core™-based processor such as an i3, i5, i7 or another such processor available from Intel Corporation. However, other low power processors such as available from Advanced Micro Devices, Inc. (AMD) of Sunnyvale, Calif., an ARM-based design from ARM Holdings, Ltd. or licensee thereof or a MIPS-based design from MIPS Technologies, Inc. of Sunnyvale, Calif., or their licensees or adopters may instead be present in other embodiments such as an Apple A7 processor, a Qualcomm Snapdragon processor, or Texas Instruments OMAP processor. Such SoC may be used in a low power system such as a smartphone, tablet computer, phablet computer, Ultrabook™ computer or other portable computing device, which may incorporate a heterogeneous system architecture having a heterogeneous system architecture-based processor design.

In the high level view shown in FIG. 10, processor 900 includes a plurality of core units 910a-910n. Each core unit may include one or more processor cores, one or more cache memories (including cache controllers as described herein) and other circuitry. Each core unit 910 may support one or more instruction sets (e.g., an x86 instruction set (with some extensions that have been added with newer versions); a MIPS instruction set; an ARM instruction set (with optional additional extensions such as NEON)) or other instruction set or combinations thereof. Note that some of the core units may be heterogeneous resources (e.g., of a different design). In addition, each such core may be coupled to a cache memory (not shown) which in an embodiment may be a shared level two (L2) cache memory. A non-volatile storage 930 may be used to store various program and other data. For example, this storage may be used to store at least portions of microcode, boot information such as a BIOS, other system software or so forth.

Each core unit 910 may also include an interface such as a bus interface unit to enable interconnection to additional circuitry of the processor. In an embodiment, each core unit 910 couples to a coherent fabric that may act as a primary cache coherent on-die interconnect that in turn couples to a memory controller 935. In turn, memory controller 935 controls communications with a memory such as a DRAM (not shown for ease of illustration in FIG. 10).

In addition to core units, additional processing engines are present within the processor, including at least one graphics unit 920 which may include one or more graphics processing units (GPUs) to perform graphics processing as well as to possibly execute general purpose operations on the graphics processor (so-called GPGPU operation). In addition, at least one image signal processor 925 may be present. Signal processor 925 may be configured to process incoming image data received from one or more capture devices, either internal to the SoC or off-chip.

Other accelerators also may be present. In the illustration of FIG. 10, a video coder 950 may perform coding operations including encoding and decoding for video information, e.g., providing hardware acceleration support for high definition video content. A display controller 955 further may be provided to accelerate display operations including providing support for internal and external displays of a system. In addition, a security processor 945 may be present to perform security operations such as secure boot operations, various cryptography operations and so forth. Each of the units may have its power consumption controlled via a power manager 940.

In some embodiments, SoC 900 may further include a non-coherent fabric coupled to the coherent fabric to which various peripheral devices may couple. One or more interfaces 960a-960d enable communication with one or more off-chip devices. Such communications may be via a variety of communication protocols such as PCIe™, GPIO, USB, I²C, UART, MIPI, SDIO, DDR, SPI, HDMI, among other types of communication protocols. Although shown at this high level in the embodiment of FIG. 9, understand the scope of the present invention is not limited in this regard.

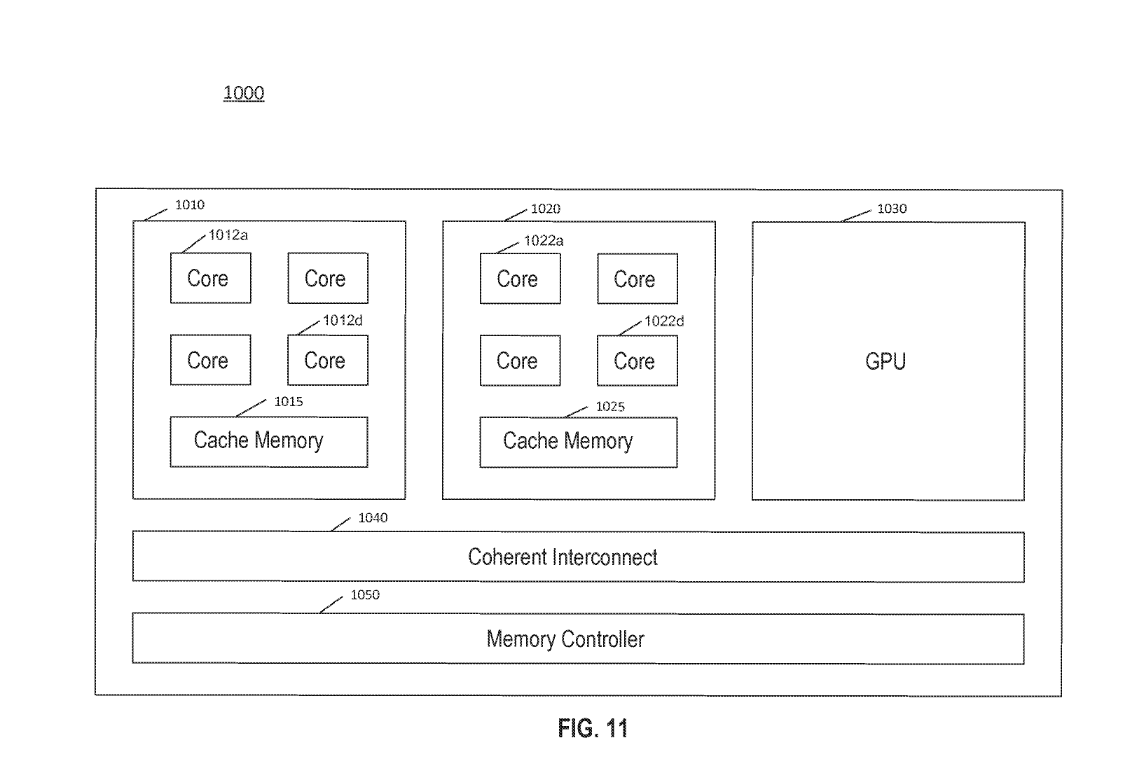

Referring now to FIG. 11, shown is a block diagram of a representative SoC. In the embodiment shown, SoC 1000 may be a multi-core SoC configured for low power operation to be optimized for incorporation into a smartphone or other low power device such as a tablet computer or other portable computing device. As an example, SoC 1000 may be implemented using asymmetric or different types of cores, such as combinations of higher power and/or low power cores, e.g., out-of-order cores and in-order cores. In different embodiments, these cores may be based on an Intel® Architecture™ core design or an ARM architecture design. In yet other embodiments, a mix of Intel and ARM cores may be implemented in a given SoC.

As seen in FIG. 11, SoC 1000 includes a first core domain 1010 having a plurality of first cores 1012a-1012d. In an example, these cores may be low power cores such as in-order cores. In one embodiment these first cores may be implemented as ARM Cortex A53 cores. In turn, these cores couple to a cache memory 1015 of core domain 1010. In addition, SoC 1000 includes a second core domain 1020. In the illustration of FIG. 11, second core domain 1020 has a plurality of second cores 1022a-1022d. In an example, these cores may be higher power-consuming cores than first cores 1012. In an embodiment, the second cores may be out-of-order cores, which may be implemented as ARM Cortex A57 cores. In turn, these cores couple to a cache memory 1025 of core domain 1020 (cache memories 1015 and 1025 may include cache controllers to handle incoming network flows on a sub-thread basis). Note that while the example shown in FIG. 11 includes 4 cores in each domain, understand that more or fewer cores may be present in a given domain in other examples.

With further reference to FIG. 11, a graphics domain 1030 also is provided, which may include one or more graphics processing units (GPUs) configured to independently execute graphics workloads, e.g., provided by one or more cores of core domains 1010 and 1020. As an example, GPU domain 1030 may be used to provide display support for a variety of screen sizes, in addition to providing graphics and display rendering operations.

As seen, the various domains couple to a coherent interconnect 1040, which in an embodiment may be a cache coherent interconnect fabric that in turn couples to an integrated memory controller 1050. Coherent interconnect 1040 may include a shared cache memory, such as an L3 cache, in some examples. In an embodiment, memory controller 1050 may be a direct memory controller to provide for multiple channels of communication with an off-chip memory, such as multiple channels of a DRAM (not shown for ease of illustration in FIG. 11). Memory controller 1050 may be configured to handle incoming requests based on priority as described herein.

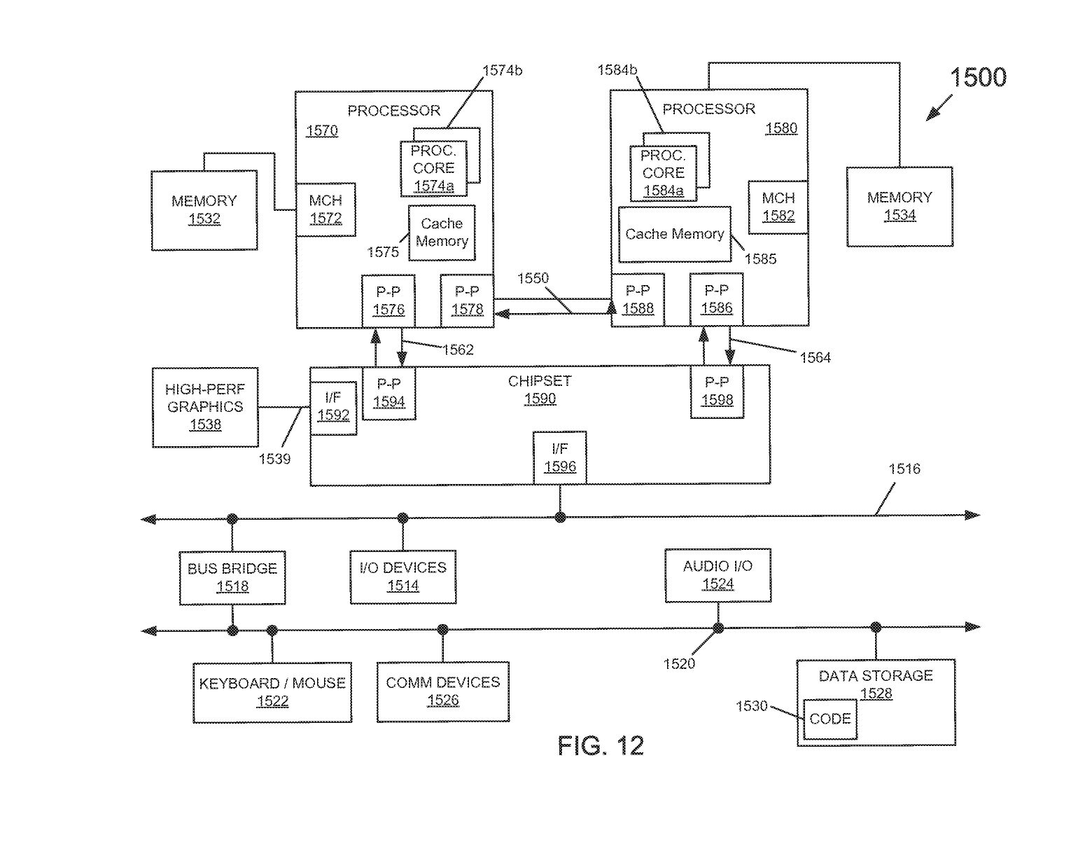

Embodiments may be implemented in many different system types. Referring now to FIG. 12, shown is a block diagram of a system in accordance with an embodiment of the present invention. As shown in FIG. 12, multiprocessor system 1500 is a point-to-point interconnect system, and includes a first processor 1570 and a second processor 1580 coupled via a point-to-point interconnect 1550. As shown in FIG. 12, each of processors 1570 and 1580 may be multicore processors, including first and second processor cores (i.e., processor cores 1574a and 1574b and processor cores 1584a and 1584b, and cache memories 1575 and 1585), although potentially many more cores and caches may be present in the processors. Each of the caches can include a cache controller to perform sub-thread level priority cache handling as described herein.

Still referring to FIG. 12, first processor 1570 further includes a memory controller hub (MCH) 1572 and point-to-point (P-P) interfaces 1576 and 1578. Similarly, second processor 1580 includes a MCH 1582 and P-P interfaces 1586 and 1588. As shown in FIG. 12, MCH's 1572 and 1582 couple the processors to respective memories, namely a memory 1532 and a memory 1534, which may be portions of system memory (e.g., DRAM) locally attached to the respective processors. First processor 1570 and second processor 1580 may be coupled to a chipset 1590 via P-P interconnects 1562 and 1564, respectively. As shown in FIG. 12, chipset 1590 includes P-P interfaces 1594 and 1598.

Furthermore, chipset 1590 includes an interface 1592 to couple chipset 1590 with a high performance graphics engine 1538, by a P-P interconnect 1539. In turn, chipset 1590 may be coupled to a first bus 1516 via an interface 1596. As shown in FIG. 12, various input/output (I/O) devices 1514 may be coupled to first bus 1516, along with a bus bridge 1518 which couples first bus 1516 to a second bus 1520. Various devices may be coupled to second bus 1520 including, for example, a keyboard/mouse 1522, communication devices 1526 and a data storage unit 1528 such as a disk drive or other mass storage device which may include code 1530, in one embodiment. Further, an audio I/O 1524 may be coupled to second bus 1520. Embodiments can be incorporated into other types of systems including mobile devices such as a smart cellular telephone, tablet computer, netbook, Ultrabook™, or so forth.

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

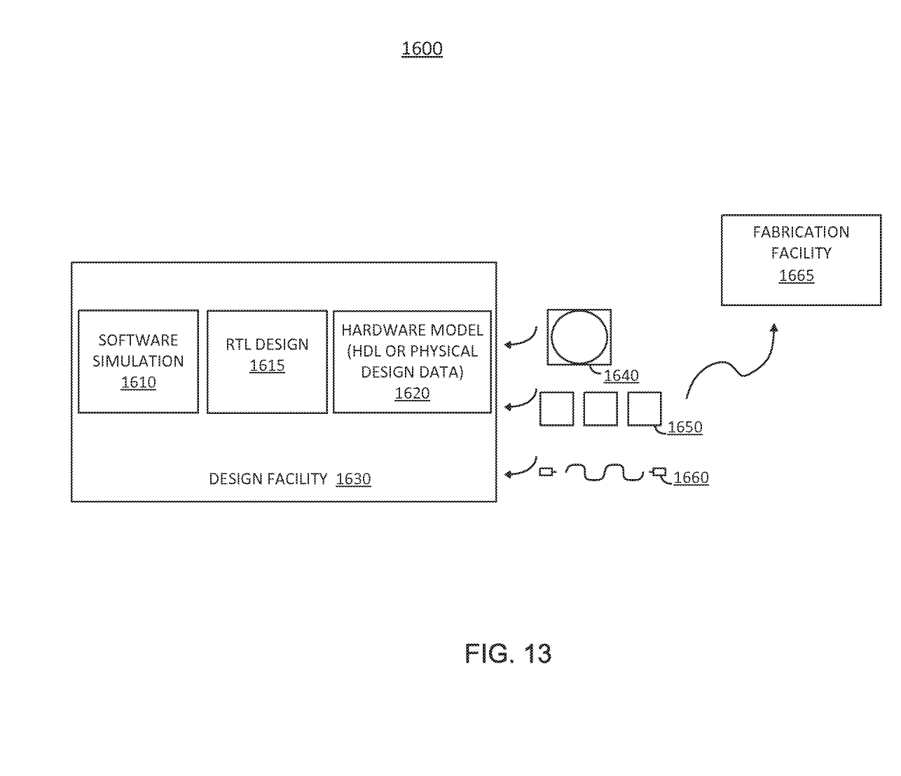

FIG. 13 is a block diagram illustrating an IP core development system 1600 that may be used to manufacture an integrated circuit to perform operations according to an embodiment. The IP core development system 1600 may be used to generate modular, re-usable designs that can be incorporated into a larger design or used to construct an entire integrated circuit (e.g., an SoC integrated circuit). A design facility 1630 can generate a software simulation 1610 of an IP core design in a high level programming language (e.g., C/C++). The software simulation 1610 can be used to design, test, and verify the behavior of the IP core. A register transfer level (RTL) design can then be created or synthesized from the simulation model 1600. The RTL design 1615 is an abstraction of the behavior of the integrated circuit that models the flow of digital signals between hardware registers, including the associated logic performed using the modeled digital signals. In addition to an RTL design 1615, lower-level designs at the logic level or transistor level may also be created, designed, or synthesized. Thus, the particular details of the initial design and simulation may vary.

The RTL design 1615 or equivalent may be further synthesized by the design facility into a hardware model 1620, which may be in a hardware description language (HDL), or some other representation of physical design data. The HDL may be further simulated or tested to verify the IP core design. The IP core design can be stored for delivery to a third party fabrication facility 1665 using non-volatile memory 1640 (e.g., hard disk, flash memory, or any non-volatile storage medium). Alternately, the IP core design may be transmitted (e.g., via the Internet) over a wired connection 1650 or wireless connection 1660. The fabrication facility 1665 may then fabricate an integrated circuit that is based at least in part on the IP core design. The fabricated integrated circuit can be configured to perform operations in accordance with at least one embodiment described herein.

The following examples pertain to further embodiments.

In one example, a processor comprises: a core to execute instructions; a cache memory coupled to the core, the cache memory having a plurality of entries, each of the plurality of entries having a metadata field to store an age indicator associated with the entry; and a cache controller coupled to the cache memory, where responsive to a first load request having a first priority level, the cache controller is to insert data of the first load request into a first entry of the cache memory and set the age indicator of the metadata field of the first entry to a first age level. The first age level is greater than a default age level of a cache insertion policy for load requests, and responsive to a second load request having a second priority level to insert data of the second load request into a second entry of the cache memory the cache controller is to set the age indicator of the metadata field of the second entry to the default age level. The first and second load requests may be of a first thread.

In an example, the first entry comprises a most recently used entry of a set of the cache memory, and the age indicator of the first entry comprises a most recently used position.

In an example, the first load request comprises a demand request of a first user-level load instruction, the first user-level load instruction to identify the first priority level.

In an example, the cache controller, responsive to a third load request having the first priority level, is to insert data of the third load request into a third entry of the cache memory and set the age indicator of the metadata field of the third entry to the default age level, where the third load request comprises a prefetch request.

In an example, the cache controller is to receive the first load request from an application, the application to identify the first priority level, where the application is associated with a different priority than the first priority level.

In an example, the application is to identify the first load request with the first priority level based at least in part on a first QoS level for a first flow associated with the first load request.

In an example, the cache controller is to associate an age indicator of the first flow with a more recent age level than the second load request of a second flow having a second QoS level.

In an example, the processor further comprising a memory controller coupled to the core, where the memory controller is to handle the first load request with a first priority and handle the second load request with a default priority of a memory controller handling policy for load requests, the first priority higher than the default priority.

Note that the above processor can be implemented using various means.

In an example, the processor comprises a SoC incorporated in a user equipment touch-enabled device.

In another example, a system comprises a display and a memory, and includes the processor of one or more of the above examples.

In another example, a method comprises: receiving, in a cache controller of a processor, a first load request having a first priority level, the first priority level higher than a default priority level; and responsive to determining that the first load request is a demand request, allocating a first cache line in a cache memory coupled to the cache controller for data associated with the first load request and setting age metadata associated with the first cache line to a first age level, the first age level closer to a most recently used position than for allocation of a cache line for a load request having the default priority level. The first load request may be associated with a first thread having a priority level different than the first priority level.

In an example, the method further comprises: responsive to a second load request comprising a prefetch request having the first priority level, allocating a second cache line in the cache memory and setting age metadata associated with the second cache line to a second age level, the second age level indicating an older age than the first age level, where the second load request is received after the first load request.

In an example, the method further comprises sending the first load request to a memory controller of the processor responsive to determining that the first load request misses in the cache memory, where the memory controller is to prioritize the first load request based at least in part on the first priority level.

In an example, the method further comprises, responsive to a hit in the cache memory for a third load request having the first priority level, returning third data associated with the third load request to a requester, and updating age metadata of a third cache line of the cache memory including the third data to the first age level.

In an example, the first load request comprises a user-level load instruction having a priority field to indicate the first priority level.

In another example, a computer readable medium including instructions is to perform the method of any of the above examples.

In another example, a computer readable medium including data is to be used by at least one machine to fabricate at least one integrated circuit to perform the method of any one of the above examples.

In another example, an apparatus comprises means for performing the method of any one of the above examples.

In a still further example, a system comprises: a processor including at least one core, a cache memory, and a cache controller. The cache controller may be adapted to receive a first load request of a first network flow of a first thread of an application, the first network flow associated with a first QoS level, and allocate a first line of the cache memory to the first load request and set age metadata of the first line to a newer age level than a default age level of an insertion policy. The cache controller may further be adapted to receive a second load request of a second network flow of the first thread, the second network flow associated with a second QoS level, and allocate a second line of the cache memory to the second load request and set age metadata of the second line to the default age level. Note that the first QoS level may be higher than the second QoS level. The system may further include a system memory coupled to the processor.

In an example, the first line comprises a way of a set of the cache memory, the age metadata of the first line comprising a most recently used position of the set.

In an example, the cache controller, responsive to a prefetch request having the first QoS level, is to allocate a third line of the cache memory to the prefetch request and set the age metadata of the third line to the default age level.

In an example, the cache controller is to receive the first load request from the application, the application to identify the first QoS level, where the application is associated with a different priority than the first QoS level.

In an example, the processor further comprises a memory controller to handle the first load request with a first priority and handle the second load request with a default priority of a memory controller handling policy for load requests, the first priority higher than the default priority.

In an example, the application is to identify QoS levels of load requests on a sub-thread basis.

In an example, the first load request comprises a first user-level load instruction having an encoding including a field for the first QoS level.

In an example, the system comprises a network device to be included in a network infrastructure, and the cache memory is to store at least a portion of a hash table to provide a map to a destination for the first network flow.

In an example, the first network flow is associated with a financial trading transaction.

In an example, the cache controller is to enable first data of the first network flow stored in the first line to be resident in the cache memory longer than second data of the second network flow stored in the second line.

In an example, the cache controller is to enable the first data to be resident longer than the second data responsive to the age metadata of the first line and the age metadata of the second line.

Understand that various combinations of the above examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
a core to execute instructions;
a cache memory coupled to the core, the cache memory having a plurality of entries, each of the plurality of entries having a metadata field to store an age indicator associated with the entry; and
a cache controller coupled to the cache memory, wherein responsive to a first load request having a first priority level, the cache controller is to insert data of the first load request into a first entry of the cache memory and set the age indicator of the metadata field of the first entry to a first age level, the first age level greater than a default age level of a cache insertion policy for load requests, and responsive to a second load request having a second priority level to insert data of the second load request into a second entry of the cache memory and to set the age indicator of the metadata field of the second entry to the default age level, the first and second load requests of a first thread.

2. The processor of claim 1, wherein the first entry comprises a most recently used entry of a set of the cache memory, and the age indicator of the first entry comprises a most recently used position.

3. The processor of claim 1, wherein the first load request comprises a demand request of a first user-level load instruction, the first user-level load instruction to identify the first priority level.

4. The processor of claim 1, wherein the cache controller, responsive to a third load request having the first priority level, is to insert data of the third load request into a third entry of the cache memory and set the age indicator of the metadata field of the third entry to the default age level, wherein the third load request comprises a prefetch request.

5. The processor of claim 1, wherein the cache controller is to receive the first load request from an application, the application to identify the first priority level, wherein the application is associated with a different priority than the first priority level.

6. The processor of claim 5, wherein the application is to identify the first load request with the first priority level based at least in part on a first quality of service (QoS) level for a first flow associated with the first load request.

7. The processor of claim 6, wherein the cache controller is to associate an age indicator of the first flow with a more recent age level than the second load request of a second flow having a second QoS level.

8. The processor of claim 1, further comprising a memory controller coupled to the core, wherein the memory controller is to handle the first load request with a first priority and handle the second load request with a default priority of a memory controller handling policy for load requests, the first priority higher than the default priority.

9. A machine-readable medium having stored thereon data, which if used by at least one machine, causes the at least one machine to fabricate at least one integrated circuit to perform a method comprising:
receiving, in a cache controller of a processor, a first load request having a first priority level, the first priority level higher than a default priority level; and
responsive to determining that the first load request is a demand request, allocating a first cache line in a cache memory coupled to the cache controller for data associated with the first load request and setting age metadata associated with the first cache line to a first age level, the first age level closer to a most recently used position than for allocation of a cache line for a load request having the default priority level, wherein the first load request is associated with a first thread having a priority level different than the first priority level.

10. The machine-readable medium of claim 9, wherein the method further comprises:
responsive to a second load request comprising a prefetch request having the first priority level, allocating a second cache line in the cache memory and setting age metadata associated with the second cache line to a second age level, the second age level indicating an older age than the first age level, wherein the second load request is received after the first load request.

11. The machine-readable medium of claim 9, wherein the method further comprises sending the first load request to a memory controller of the processor responsive to determining that the first load request misses in the cache memory, wherein the memory controller is to prioritize the first load request based at least in part on the first priority level.

12. The machine-readable medium of claim 9, wherein the method further comprises, responsive to a hit in the cache memory for a third load request having the first priority level, returning third data associated with the third load request to a requester, and updating age metadata of a third cache line of the cache memory including the third data to the first age level.

13. The machine-readable medium of claim 9, wherein the first load request comprises a user-level load instruction having a priority field to indicate the first priority level.

14. A system comprising:
a processor including at least one core, a cache memory, and a cache controller, wherein the cache controller is to receive a first load request of a first network flow of a first thread of an application, the first network flow associated with a first quality of service (QoS) level, and allocate a first line of the cache memory to the first load request and set age metadata of the first line to a newer age level than a default age level of an insertion policy, and receive a second load request of a second network flow of the first thread, the second network flow associated with a second QoS level, and allocate a second line of the cache memory to the second load request and set age metadata of the second line to the default age level, the first QoS level higher than the second QoS level; and
a system memory coupled to the processor.

15. The system of claim 14, wherein the first line comprises a way of a set of the cache memory, the age metadata of the first line comprising a most recently used position of the set.

16. The system of claim 14, wherein the cache controller, responsive to a prefetch request having the first QoS level, is to allocate a third line of the cache memory to the prefetch request and set the age metadata of the third line to the default age level.

17. The system of claim 14, wherein the cache controller is to receive the first load request from the application, the application to identify the first QoS level, wherein the application is associated with a different priority than the first QoS level.

18. The system of claim 14, wherein the processor further comprises a memory controller to handle the first load request with a first priority and handle the second load request with a default priority of a memory controller handling policy for load requests, the first priority higher than the default priority.

19. The system of claim 14, wherein the application is to identify QoS levels of load requests on a sub-thread basis.

20. The system of claim 19, wherein the first load request comprises a first user-level load instruction having an encoding including a field for the first QoS level.

21. The system of claim 14, wherein the system comprises a network device to be included in a network infrastructure, and the cache memory is to store at least a portion of a hash table to provide a map to a destination for the first network flow.

22. The system of claim 14, wherein the first network flow is associated with a financial trading transaction.

23. The system of claim 14, wherein the cache controller is to enable first data of the first network flow stored in the first line to be resident in the cache memory longer than second data of the second network flow stored in the second line.

24. The system of claim 23, wherein the cache controller is to enable the first data to be resident longer than the second data responsive to the age metadata of the first line and the age metadata of the second line.
